(19) United States
(12) Patent Application Publication
(10) Pub. No.: US 2007/0191569 A1
(43) Pub. Date: Aug. 16, 2007

(54) Isocyanate-based compositions, their process for utilization, their utilization for producing coatings and coatings thus obtained

(76) Inventors: Minou Nabavi, Paris (FR); Thierry Jeannette, Garches (FR); Arnaud Lyothier, Aubervilliers (FR); Jean-Marie Bernard, Mornant (FR)

Correspondence Address: RHODIA INC, 8 CEDAR BROOK DRIVE, CN 7500, CRANBURY, NJ, 08512, US

(21) Appl. No.: 11/787,088

(22) Filed: Apr. 13, 2007

Related U.S. Application Data
(63) Continuation of application No. 11/006,943, filed on Dec. 8, 2004.
Application No. 11/006,943 is a continuation of application No. 10/355,584, filed on Jan. 31, 2003, now abandoned.
Application No. 10/355,584 is a continuation of application No. 09/810,137, filed on Mar. 16, 2001, now abandoned.
Application No. 09/810,137 is a continuation of application No. 08/945,873, filed on Oct. 20, 1997, now abandoned.

(30) Foreign Application Priority Data
Feb. 29, 1996 (FR) 96/02710

(51) Int. Cl. C08G 18/00

(52) U.S. Cl. 528/44

(57) ABSTRACT

The present invention relates to a composition based on isocyanate(s), advantageously not completely masked. This composition is defined in that it comprises a compound containing an anionic functional group and a polyethylene glycol chain fragment of at least 5, advantageously of at least 7 ethyleneoxy units. Application to organic synthesis.

The present invention relates to isocyanate-based compounds and compositions (which may be partially masked, but this is not the preferred application). It also relates to their process for utilization, their utilization for producing coatings and coatings thus obtained. It relates more particularly to compositions that are (auto)dispersible in aqueous phase.

For better understanding of the invention it has seemed opportune to give the following reminders.

In the present description the particle size characteristics often refer to notations of the dₙ type where n is a number from 1, to 99, this notation is well known in many technical fields but is a little rarer in chemistry, and so it may be useful to recall its meaning. This notation represents the particle size such that n % (by weight, or more precisely by mass, since weight is not a quantity of matter but a force) of the particles is smaller than or equal to the said size.

In the following description the polydispersity index will be employed, which is defined as
I=(d₉₀−d₁₀)/d₅₀

In the activity involving paints and varnishes, diisocyanates are widely employed, especially alkylene diisocyanates (for example those sold under the trademark Tolonate) and their derivatives of biuret type or their trimers.

However, two problems remain incompletely solved to this date, namely:
the use of organic solvent, the presence of which is reputed to be toxic and detrimental to the environment;
the need to put nonvolatile products on the market, which has led to the molecules being made heavier, this being done by oligomerizing the diisocyanates; this solution is not wholly satisfactory because it employs an elaborate, and therefore costly, functional group to solve the problem.

These problems must, of course, be solved while remaining within the constraints that are intrinsic to coatings.

To produce paint or varnish films a mixture is made of, on the one hand, a dispersion, or an emulsion, containing the isocyanate, which may be blocked, and, on the other hand, a dispersion or a solution of polyol.

The mixture of the dispersions, which may also contain pigments, and especially titanium dioxide, the dispersion of which is improved by the present invention, and fillers, is then deposited on a substrate in the form of a film with the aid of conventional techniques for the application of industrial paints.

When the preparation contains blocked isocyanates the combination of film plus substrate is cured at a temperature that is sufficient to ensure the unblocking of the isocyanate functional groups and their condensation with hydroxyl groups of the polyol particles. It is appropriate, however, to recall that the cost of manufacture of masked or blocked products is significantly higher than that of unmasked products.

The use of organic solvents is increasingly frequently criticized by the authorities in charge of work safety because these solvents, or at least some of them, are reputed to be toxic or chronotoxic. This is the reason why attempts are made to develop increasingly techniques which are substituted for techniques in a solvent medium in order to overcome the disadvantages related to solvents.

One of the most frequently employed solutions lies in the use of emulsions or dispersions in water. Because of the reactivity of water with isocyanates, this solution is employed above all in the case of masked isocyanates.

In order not to fall from Charybdis to Scylla, a major hazard is to be avoided, namely that of detriment to one or more of the essential qualities of the coatings [smooth nature (avoiding “orange peel”) hardness, resistance to solvents, etc.], a poor adhesion of the coating to its substrate must be feared in particular. In fact, many surfactants are reputed to damage the firmness of the bond between the coating and its substrate and are known and employed to impair the bonding between a polymer and a substrate. (confer, for example, DE-OS 3,108,537).

When unmasked or incompletely masked isocyanates are employed, the period of time during which it [sic] can be employed remains shorter than a few hours, In general one or two hours.

It is thus important not to encounter any difficulty when isocyanates are being emulsified or dispersed.

This is why one of the objectives of the present invention is to provide a composition which, by mixing in water or more precisely in an aqueous phase, makes it possible to obtain an emulsion without it being necessary to employ specific techniques and/or equipment for this purpose.

Another objective of the present invention is to provide a composition of the above type which does not perturb the coating operations.

Another objective of the present invention is to provide a composition of the above type in which the solvent content is lower than ⅕, advantageously 1/10, of the mass of the said composition. It is preferable, of course, that there should be as little as possible thereof, or even none at all.

These objectives, and others which will appear in what follows, are achieved by means of a composition based on isocyanate(s), advantageously not masked, where it comprises at least one compound containing an anionic functional group and advantageously a polyethylene glycol chain fragment of at least 1, preferably of at least 5 ethyleneoxy units

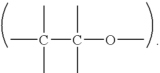

thus the present invention is aimed for successive or simultaneous addition, at a composition comprising especially:
a sub-composition carrier of isocyanate functional groups whose preferred characteristics will be detailed later and
a surface-active agent containing at least one compound containing an anionic functional group and advantageously a polyethylene glycol chain fragment of at least 1, preferably of at least 5 ethyleneoxy units 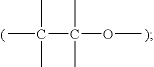
optionally an aqueous phase.

According to the present invention the said compound maybe [sic] employed alone or as a mixture with one or several surface-active agents. The latter may be agents also conforming to the above necessity of containing an anionic functional group and advantageously a polyethylene glycol chain fragment preferably of at least 5 ethyleneoxy units.

These optional surface-active agents may also be chosen from other ionic compounds [especially aryl and/or alkyl sulphate or phosphate (of course aryl includes especially alkylaryls and alkyl includes especially aralkyls), aryl- or alkyl phosphonate, -phosphinate, sulphonate, fatty acid salt and/or zwitterionic] and among the nonionic compounds those blocked at the end of a chain or not. (however the nonionic compounds which have alcoholic functional groups on at least one of the chains seem to have a slightly unfavourable effect on the (auto)emulsion even though they have a favourable effect on other aspects of the composition for painting; bearing this in mind, it is preferable that the content of this type of compound represent [sic] at most one third, advantageously at most one fifth, preferably at most one tenth of the mass of the said anionic compounds according to the invention)

The said compound advantageously contains a hydrophilic part formed of the said anionic functional group, of the said (optional) polyethylene glycol chain fragment and of a lipophilic part based on a hydrocarbon radical.

The said lipophilic part is generally chosen from alkyl groups [in the present description ALK-yl is taken in its etymological sense of hydrocarbon residue of an ALK-ol after disregarding the alcohol (or ol) functional group]; and aryl groups. When the number of ethylene glycol functional group is at most equal to 5, the simple alkyls are advantageously branched, advantageously from C₈ to C₂, the aralkyls C₁₂ to C₁₆, the alkylaryls from C₁₀ to C₁₄ and the simple aryls are C₁₀ to C₁₆ Otherwise the lipophilic part can vary widely above all when the number of ethylene glycol units is above 10, it may thus constituted [sic] a hydrocarbon radical of at least 1, advantageously of at least 3 and containing at most 25 advantageously at most 20 carbon atoms.

The said compound advantageously corresponds to the following formula I.

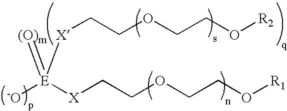

Where q denotes zero or 1;
where p denotes an integer between 1 and 2 (closed intervals, that is to say including the limits);
where m denotes zero or an integer between 1 and 2 (closed intervals, that is to say including the limits);
where X and X′, which are similar or different, denotes [sic] an arm containing at most two carbon chain links;
where s is zero or an integer chosen between 1 and 30 advantageously between 5 and 25, preferably between 9 and 20 (closed intervals, that is to say including the limits);
where n is zero or an integer chosen between 1 and 30 advantageously between 5 and 25, preferably between 9 and 20 (closed intervals, that is to say including the limits);
where E is an element chosen from carbon and the metalloid elements of atom row at least equal to that of phosphorus and belonging to column VB or to the chalcogens of atom row at least equal to that of sulphur;.
where R₁ and R₂, which are similar or different, denote a hydrocarbon radical, advantageously chosen from optionally substituted aryls and alkyls.

Although this does not form part of the preferred compounds, it is appropriate to note that s and/or n can be equal to zero, with the condition that E is phosphorus and that when s and n are equal to zero, R1 and/or R2 are respectively alkyls from C₈ to C₁₂, advantageously branched, or an aralkyl from C₁₂ to C₁₆ or an alkylaryl from C₁₀ to C₁₄.

One of the divalent radicals X and X′ can also be a radical of type ([EOₘ(O⁻)ₚ]) so as to form pyroacids like the symmetric or otherwise diesters of pyrophosphoric acid.

The total carbon number of the anionic compounds aimed at by the present invention is advantageously at most approximately 100, preferably at most approximately 50.

The divalent radicals X and optionally X′ are advantageously chosen from the divalent radicals consisting of (the left-hand part of the formula being bonded to the first E):
when E is P, one of the X or X′ may be O—P (O) (O^{—)—X″—;}
when E is P, one of the X or X′ may be —O—(R₁₀—O)P(O)—X″—; (R₁₀ being defined below) (X″ denoting an oxygen or a single bond);
a direct bond between E and the first ethylene of the said polyethylene glycol chain fragment;
methylenes which are optionally substituted and in this case advantageously partly functionalized;
the arms of structure —Y— and of structure -D-Y—, —Y-D- or —Y-D-Y′
   where Y denotes a chalcogen (advantageously chosen from the lightest ones, namely sulphur and above all oxygen), metalloid elements of the atom rows at most equal to that of phosphorus and belonging to column VB in the form of derivatives of amines or of tertiary phosphines (the radical providing the tertiary character being advantageously of at most 4 carbons, preferably of at most 2 carbons);
   where D denotes an alkylene which is optionally substituted, including functionalized, D being advantageously ethylene or methylene, preferably ethylene in the structures -D-Y— and above all —Y-D-Y′, and methylene in the structures —Y-D-,

Thus, E denotes an atom chosen from carbon atoms (advantageously in this case m=1 and p=1, the proto-type of this type of compound is an alcohol acid [For example lactic or glycolic acid] which is polyethoxylated) the atoms giving salts containing an element of group VB (elements As or Sb) (elements of column VB) (advantageously in this case m=1 or 0 and p=1 or 2), chalcogen atoms of row higher than oxygen (advantageously in this case m=1 or 2 and p=1 and q =0).

Thus in the case where E is chalcogen the formula I is advantageously simplified to:

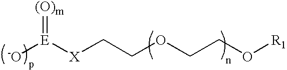

E advantageously denotes carbon and above all phosphorus or sulphur, preferably phosphorus:
in this latter case the formula (I) becomes the formula (II):

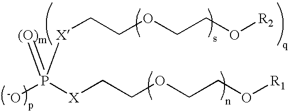

With, when q is zero: 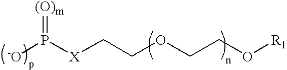
Where p denotes zero or an integer between 1 and 2 (closed intervals, that is to say including the limits);
where m denotes zero or an integer between 1 and 2 (closed intervals, that is to say including the limits);
where the sum p+m+q is at most equal to three;
where the sum 1+p+2m+q is equal to three or to five;
where X and X′, which are similar or different, denote an arm containing at most two carbon chain links;
where n and s, which are similar or different, denote an integer chosen between 5 and 30 advantageously between 5 and 25, preferably between 9 and 20 (closed intervals, that is to say including the limits); where R₁ and R₂, which are similar or different, denote a hydrocarbon radical advantageously chosen from aryls and alkyls which are optionally substituted especially by halogen atom especially fluorine.

The Periodic Classification of the Elements employed in the present application is that in the supplement to the Bulletin de la Société Chimique de France, January 1966, No. 1.

The optional functionalization of the alkylenes and especially methylenes (X and X′) is done by hydrophilic functional groups (tertiary amines and other anionic functional groups including those which are described above [EOₘ(O—)ₚ]).

The countercation is advantageously monovalent and is chosen from inorganic cations and organic cations, advantageously nonnucleophilic and consequently of quaternary or tertiary nature (especially oniums of column V, such as phosphonium, ammoniums, or even of column VI, such as sulphonium, etc.) and mixtures thereof, in most cases ammoniums, in general originating from an amine, advantageously tertiary. The presence on the organic cation of a hydrogen that is reactive with the isocyanate functional group is advantageously avoided. Hence the preference for. tertiary amines.

The inorganic cations may be sequestered by phase transfer agents like crown ethers

The pKa of the cations (organic [ammonium etc.] or inorganic ones) is advantageously between 8 and 12.
The cations and especially the amines corresponding to the ammoniums advantageously do not exhibit any surface-active property but it is desirable that they should exhibit a good solubility, sufficient in any event to ensure it in the said compounds containing an anionic functional group and advantageously a polyethylene glycol chain fragment, in aqueous phase, this being at the concentration for use. Tertiary amines containing at most 12 atoms, advantageously at most 10 atoms, preferably at most 8 atoms of carbon per “onium” functional group (it must be remembered that it is preferred that there should be only one thereof per molecule) are preferred. The amines may contain another functional group and especially the functional groups corresponding to the amino acid functional groups and cyclic ether functional groups like N-methylmorpholine, or not. These other functional groups are advantageously in a form that does not react with isocyanate functional groups and do not significantly alter the solubility in aqueous phase.

It is highly desirable that the anionic compounds according to the present invention should be in a neutralized form such that the pH which it induces when being dissolved in, or brought into contact with water, is at least equal to 3, advantageously to 4, preferably to 5 and at most equal to 12, advantageously to 11, preferably to 10.

When E is phosphorus it is desirable to employ mixture ([sic] of monoester and of diester in a molar ratio of between 1/10 and 10, advantageously between ¼ and 4. Such mixture [sic] may additionally contain from 1% up to approximately 20% (it is nevertheless preferable that this should not exceed approximately 10%) by mass of phosphoric acid (which would be advantageously at least partially converted into salt form so as to be within the recommended pH ranges). and from 0 to 5% of pyrophosphoric acid esters.

The mass ratio between the surface-active compounds (including the said compound containing an anionic functional group and advantageously a polyethylene glycol chain fragment) and the isocyanates is very preferably between 4 and approximately 10%. The recommended ranges will be explained later.

The composition may additionally comprise a catalyst which is advantageously latent (capable of being released by the action of external agents, for example visible or UV radiation or oxygen).

After being converted into dispersion or emulsion in an aqueous phase, the isocyanate composition according to the invention may have a water content of 10 to 70%. The emulsion is an oil-in-water emulsion.

However, in the course of the investigation which has led to the present invention, in particular in the case of aliphatic isocyanates (that is to say which are bonded to the hydrocarbon backbone (that is to say. containing both hydrogen and carbon) through the intermediacy of a saturated (sp³) carbon It has been shown that there is a risk of runaway of various reactions when certain proportions of water is [sic] reached, Consequently it is prudent to avoid compositions where the mass ratio between, on the one hand, the quantity of water in the aqueous phase and, on the other hand, the sum of the isocyanate and of the surfactant according to the invention is between 10⁻² and one half. If greater safety is desired then the ratios of between 10⁻³ and 1 will be avoided.

The emulsions obtained exhibit in the case of the isocyanate part d₅₀ values at least equal to 0.1 micrometre, more frequently to 0.5 micrometre and they exhibit a d₅₀, preferably a d₈₀, advantageously ≦ (at most equal to) 5 micrometres, preferably to 3 micrometres.

The aqueous phase of the emulsion generally serves as carrier for the coreactants which can be polycondensed with the isocyanate functional groups and therefore comprises compounds exhibiting functional groups (advantageously at most 4, preferably at most 3 functional groups cf. what is explained below in the case of the polyol which general [sic] mutatis mutandis to all the functionality of this type) containing reactive hydrogens, in general one or more polyols.

This polyol is a polymer which contains at least 2 hydroxyl groups (phenol or alcohol) which advantageously has a proportion of hydroxyl of between 0.5 and 5, advantageously between 1 and 3% (by mass). Except in the case of the latices, which will be recalled later, It advantageously contains at most 4, preferably at most 3 primary alcohol functional groups (but in most cases two because the actual crosslinking [caused by a functionality that is statistically higher than two (possible fractional value)] is generally engendered by polyisocyanates). However, it may additionally contain secondary or tertiary alcoholic functional groups (in general at most approximately 10, advantageously at most 5, more frequently at most two) which, in general, do not react or react only after the primary ones, this being in the order primary, secondary and tertiary.

Polyoses or polyosides (starch, cellulose, gums (guar, carob, xanthan, etc.) of various kinds etc.) are to be avoided, especially in solid form. In the form of a texturing agent, and insofar as this does not interfere with the conversion into emulsion and the stability of the latter, they can, however, be employed to impart particular properties (For example thixotropy etc.). The polymer backbone may be of diverse chemical nature, especially acrylic, polyester, alkyd, polyurethane or even amide, including urea.

The polyol may contain anionic groups, especially carboxylic or sulphonic, or may not contain any ionic group.

Within the scope of the present invention it has been shown that the present [sic] of anionic carboxylate functional group (—CO₂⁻) significantly increases the kinetics of drying, which is particularly advantageous in order to obtain a rapid “dust-free”, especially when operating outside. A significant effect can be noted with a ratio of at least one carboxylic functional group per approximately 20 functional groups containing reactive hydrogen [alcohol or phenol functional group], advantageously with a ratio of one per approximately 10, preferably with a ratio of one per approximately 5; it is however desirable that this ratio should at most be equal to one functional group per one functional group, preferably of one carboxylic. functional group per two ol functional groups. The countercations of the carboxylate advantageously correspond to the same preference as those expressed for the countercation of the compound according to the present invention.

The polyol can already be in an aqueous or water-soluble or water-dispersible medium.

It may be an aqueous solution (which may in particular be obtained after neutralization of the ionic groups) or an emulsion of the polymer in water or a dispersion of latex type.

It seems possible to disperse a standard polyisocyanate in a water-soluble polyol in some conditions of formulation (especially with a ratio of pigment to paint binder which is suitable). However the use of standard polyisocyanates with water-dispersed polyols (resin emulsion or latex types) frequently presents problems of incompatibility (flocculation, appearance of several phases etc.). One of the many advantages of the preparation according to the invention is that it offers a great freedom of choice for the formulation (physical form of the polyol, pigment-to-binder ratio, ease of incorporation into aqueous media).

Furthermore, from the wear values of the coatings (especially chemical resistance and hardness) it has been found that the crosslinking of the films is much greater when the polyol employed is carboxylated.

In particular it is advantageously possible to employ latices, especially nanolatices (that is to say latices in which the particle size is nanometric [more precisely in which the d₅₀ is at most equal to approximately 100 nanometres])

Thus, according to one of the particularly advantageous applications of the present invention, the polyol is advantageously a latex of nanometric size exhibiting the following characteristics:
d₅₀ of between 15 and 60 nm, advantageously between 20 and 40 nm
carboxylate functional group from 0.5 to 5% by mass
ol functional group: between 1 and 4% advantageously between 2 and 3%
solid content: between 25 and 40%
a d₈₀ smaller than 1 micrometre

In addition, the latices, above all when their glass transition point is lower than 0° C., advantageously than −10° C., preferably than −20° C., make it possible to obtain even with aromatic isocyanates good quality of resistance to inclement weather and especially to temperature variations.

The molar ratio between the free isocyanate functional groups and the hydroxyl functional groups is between 0.5 and 2.5, advantageously between 0.8 and 1.6, advantageously between 1 and 1.4.

The latices (which are not functionalized in respect of isocyanate which are optionally masked) which are described in the French Patent Application filed on 28 Apr. 1995 No. 95/05123 and in the European Patent Reflex Application No. EP 0,739,961 give very good results.

Thus the latex particles advantageously exhibit an acidic (advantageously carboxylic) functional group content which is accessible of between 0.2 and 1.2 milliequivalents/gramme of solid content and they exhibit an accessible alcoholic functional group content of between 0.3 and 1.5 milliequivalents/gramme.

Thus, as indicated in this document the latices consisting of particles carrying functional group(s) according . to the invention are preferred, are hydrophobic and advantageously have a size (d₉₀) which is generally between 0.01 micrometre and 10 micrometres and preferably at most equal to 5 micrometres or even to 2 micrometres. They are calibrated, monodisperse, and resent in the latex in a proportion of a quantity varying between 0.2 to 65% by weight of the total eight of the latex.

The weight-average molecular mass (M_{w}, referably determined by gel permeation chromatography, nown as “GPC”) of the polymers constituting the articles of the population A (latex containing ol unctional group acting as polyol) is advantageously between 5×10⁴ and 5×10⁶, preferably 0.8 10⁵ and 2×10⁶.

The alcoholic functional groups or the acidic, preferably carboxylic, functional groups may also be obtained by hydrolysis of alcohol-forming functional groups (ester, ether, halide etc.) or of acid-forming functional groups (ester, anhydride, acid chloride, amide, nitrile etc.).

The distribution between the various types of units advantageously conforms to the following rules:

The content of unit originating from the monomer consisting of the said free alcohol exhibiting an activated ethylenic functional group, and referred to the totality of the units of any kind, is advantageously between 3 and 15%, preferably between 4 and 10% (mole or equivalent).

According to an advantageous method of the present invention the unit originates from an ester, of an alpha ethylenic acid, with a diol in which one of the alcohol functional groups remains unesterified. The said diol is advantageously an omega/omega prime diol advantageously chosen from 1,4-butanediol, 1,3-propanediol and glycol.

It is desirable that the said alpha ethylenic acid should be an optionally substituted acrylic acid.

According to. a preferred method of the present invention the content of unit derived from a free carboxylic acid (or in the form of one of its salts) and related to the totality of the units of any kind, is between 2 and 10% (mole).

For economic reasons it is often advantageous for the said free acid to be an optionally monosubstituted acrylic acid or one of its salts.

The particles originating from the present invention may consist of two distinct polymers, the first forming the core and the second forming the periphery. This type of particle can be obtained by epipolymerization [where a latex seed is covered by surface polymerization (epipolymerization, sometimes referred to as overpolymerization)] of a distinct polymer. The core is sometimes called seed by analogy with the crystallization phenomenon. In this case only the second polymer, that is to say the surface polymer, meets the concentration constraints at the various functional groups according to the present invention.

The mass ratio between the isocyanates to be placed in suspension and the said compounds containing an anionic functional group and advantageously a polyethylene glycol chain fragment is in most cases at most equal to ⅓ advantageously at most equal to approximately 20%, preferably to approximately 10%. (in the present description the term “approximately” is employed to stress the fact that when the digit(s) on the extreme right of a number are zeros, these zeros are position zeros and not significant digits, except, of course, when stated otherwise).

The mass ratio between the isocyanates to be suspended and the said compound containing an anionic functional group and advantageously a polyethylene glycol chain fragment is advantageously higher than 1%, preferably than 2%.

It is also desirable that the quantity of the said compound(s) containing an anionic functional group and advantageously a polyethylene glycol chain fragment should correspond to a value of between 10⁻² and 1, advantageously between 5×10⁻² and 0.5 atom of E per litre Thus the mass ratio between the isocyanates to be suspended and the said compound containing an anionic functional group and advantageously a polyethylene glycol chain fragment is advantageously at least equal to 2%, preferably to 4% and at most equal to approximately 20%, preferably to approximately 10%, thus this mass ratio is advantageously between and approximately 20, preferably between 4 and approximately 10%.

According to a particularly advantageous application of the present invention, after being dispersed or emulsified, the sum of the constituents of the binder (that is to say the mass contents of the isocyanate(s), emulsifier(s) and polyol(s)) in water varies from 30 to 70% relative to the totality of the composition.

The isocyanates aimed at by the invention comprises [sic] especially the compounds detailed below.

These compounds may advantageously contain the structures which are common in this field for example the prepolymers originating from the condensation of polyol (For example trimethylolpropane) in general triol (advantageously primary see below on the definition of the polyols) and above all the most common ones, namely those of isocyanurate type, also called trimer, uretidinedione structures, also called dimer, biuret or allophanate structures or a combination of this type of structures on one molecule alone or as mixture.

If it is desired to greatly lower the solvent content of the composition, especially when it is in the form of emulsion, it is preferable to employ mixtures of this type naturally (that is to say without addition of solvent) with low viscosity. The compounds exhibiting this property are above all the derivatives (isocyanurate type, also called trimer, uretidinedione structures, also called dimer, biuret or allophanate structures or a combination of this type of structures on one molecule alone or as mixture) partially and/of totally of the aliphatic isocyanates in which the isocyanate functional groups are joined to the backbone through the intermediacy of ethylene fragments (For example polymethylene diisocyanates, especially hexamethylene diisocyanate and those of the arylenedialkylene diisocyanates in which the isocyanate functional group is at a distance of at least two carbons from the aromatic nuclei, such as (OCN—[CH₂]ₜ-Φ-[CH₂]ᵤ-NCO) with t and u greater than 1). These compounds or mixtures advantageously have a viscosity at most equal to approximately 3000 centipoises (or millipascal second), preferably to approximately 1500 centipoises (or millipascal second).

When these values are not attained It is then often useful to bring the mixture to these viscosity values by the addition of a minimum quantity of appropriate solvent(s). As already mentioned above, the isocyanates concerned may be mono-, di- or even polyisocyanates. These derivatives may advantageously contain structures of isocyanurate type, also called trimer, uretidinedione structures, also called dimer, biuret or allophanate structures or a combination of this type of structures in one molecule alone or as mixture.

The monomeric isocyanates may be:
aliphatic, including cycloaliphatic and aryl-aliphatic, such as:
   as simple aliphatic, polymethylene diisocyanates and especially hexamethylene diisocyanate;
   as aliphatic partially “neopentylic” partially cyclic (cycloaliphatic) isophorone diisocyanate (IPDI);
   as cyclic aliphatic (cycloaliphatic) diisocyanate those derived from norbornane;
   arylenedialkylene diisocyanates (such as OCN—CH₂-Φ—CH₂—NCO a part of which does not exhibit any essential difference from the aliphatics namely those in which the isocyanate functional group is at a distance of at least two carbons from the aromatic nuclei, such as (OCN-[CH₂]ₜ-Φ-[CH₂]ᵤ-NCO) with t and u greater than 1;
or else aromatic ones such as tolylene diisocyanate.

The preferred polyisocyanates aimed at by the technique of the invention are those in which at least one, advantageously two, preferably three of the conditions below are fulfilled:
At least one, advantageously at least two, of the NCO functional groups are -joined to a hydrocarbon backbone through the intermediacy of a saturated (Sp³) carbon, preferably with at least one, more preferably at least two of the subconditions below:
   At least one, advantageously two, of the said saturated (sp³) carbons carries at least one, advantageously two, hydrogen(s), (in other words it has been found that better results are obtained when the carbon carrying the isocyanate functional group carries one hydrogen, preferably two hydrogens);
at least one, advantageously two, of the said saturated (sp³) carbons are themselves carried by a carbon which is advantageously aliphatic (that is to say with sp³ hybridization), itself carrying at least one, advantageously two, hydrogen(s); in other words, it has been found that better results are obtained when the carbon carrying the isocyanate functional group is not in a so-called “neopentylic” position;
   All the carbons through the intermediacy of which the isocyanate functional groups are joined to the hydrocarbon backbone are saturated (Sp³) carbons which are advantageously partially, preferably totally, carrying one hydrogen, preferably two hydrogens; in addition it is advantageous that the said saturated (sp³) carbons should be at least partially (advantageously one third, preferably two thirds), preferably totally, themselves carried by a carbon, advantageously aliphatic (that is to say with sp³ hybridization), itself carrying at least one, advantageously two, hydrogen(s); in other words, it has been found that better results are obtained when the carbon carrying the isocyanate functional group is not in a so-called “neopentylic” position;
Particularly well suited are those which exhibit at least partially. an isocyanuric or biuret backbone (regardless of whether this backbone originates from only one or a number of monomers, see below) and more precisely structures of isocyanurate type, also called trimer, uretidinedione structures, also called dimer, biuret or allophanate structures or a combination of this type of structures on one molecule alone or as mixture.

When the polyisocyanates are relatively heavy, that is to say when they contain at least 4 isocyanate functional groups, the first two conditions become:
At least one third, advantageously two thirds, of the NCO functional groups are joined to a hydrocarbon backbone through the intermediacy of a saturated (sp³) carbon;.
   At least one third, advantageously two-thirds of the said saturated (Sp³) carbons carries at least one, advantageously two, hydrogen(s), (in other words it has been found that better results are obtained when the carbon carrying the isocyanate functional group carries one hydrogen, preferably two hydrogens.; In addition it is advantageous that the said saturated (sp³) carbons should be at least partially (advantageously one third, preferably two thirds), preferably in totality, themselves carried by a carbon, advantageously aliphatic (that is to say with sp³ hybridization), itself carrying at least one, advantageously two, hydrogen(s); in other words, it has been found that better results are obtained when the carbon carrying the isocyanate functional group is not in a so-called “neopentylic” position;

The, in particular aliphatic, isocyanates react with some of the anionic compounds aimed at by the invention it [sic] react with the hydroxyl of the unneutralized or poorly neutralized acidic functional groups. these compound [sic] are also aimed at by the present invention.

In particular in the case of phosphates (m=l) they react to give compounds of the type:

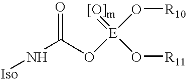

but when E belongs to the phosphorus column and when m (which is the same as in formula I) is equal to zero the compound isomerizes (or acts directly) to give: 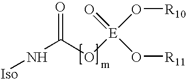
Where E is an element of column VA [lacuna] the Periodic Classification of the Elements [(supplement to the Bulletin de la Société Chimique de France January, 1966 No.1) advantageously phosphorus]. And therefore especially of the type: 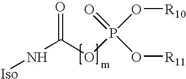
Where Iso is the residue (of a poly)isocyanate (after removal of one isocyanate functional group)
where R₁₀ is a hydrocarbon residue (that is to say containing hydrogen and carbon atoms) whose point of attachment [that is to say the atom carrying the open bond] is a carbon
where R₁₁ is chosen from:
   a negative charge;
   a group of formula II: 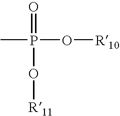
      in which R′₁₀ is chosen from hydrocarbon residues (similar to or different from R₁₀ ) and a negative charge whose point of attachment [that is to say the atom carrying the open bond] is a carbon
      in which the R′₁₁ (s) is(are) chosen from hydrocarbon residues whose point of attachment [that is to say the atom carrying the open bond] is a carbon (which are similar to or different from R₁₀ and from R′₁₁) and a negative charge.

It is desirable that at least one of the organic substituents (R₁₀; R′₁₁; R′₁₀) should contain a polyethylene glycol chain fragment advantageously of at least 5, preferably of at least 7 ethyleneoxy units. In other words it is desirable that at least. one of the organic substituents should correspond to the [lacuna] of same formula as the substituents of E in the general formula I. More specifically at least one of the organic substituents (R₁₀; R′₁₁; R′₁₀) corresponds to the formula 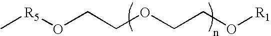
Where R₅ denotes an arm containing at most two carbon chain units (with the same preferred values as X′ and X)
where n is an integer chosen between 0 and 30 advantageously between 5 and 25, preferably between 9 and 20 (closed intervals, that is to say including the limits);

where R₁ denotes a hydrocarbon radical advantageously chosen from optionally substituted aryls and alkyls.

Thus, according to an advantageous alternative form of the present invention, the compositions according to the present invention exhibits [sic] compounds originating from the reaction which are set out below in an overall proportion, in relation to a volume of one litre of isocyanate, of 0.01 to 1, advantageously of 0.05 to 0.5, preferably of 0.05 to 0.3 equivalent of functional group:

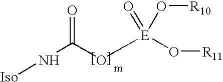

It is advantageous that the Iso radical should provide predominantly or totally an aliphatic bond with the same preference as those set out below with regard to the isocyanates.

Also forming part of the invention are the compounds of formula

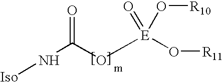

In which R10 and R11 can assume the above values but also when m is 1, can be a negative charge because of the fact that in some batch there may be significant quantities of residual phosphoric acid.

Of course, R₁₀ can then also have the value:

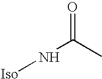

It being possible for the Iso radical then to be or not to be the same as that in the penultimate formula.

in which Iso denotes the residue of a polyisocyanate, advantageously of a product of reaction of a diisocyanate monomer to form biuret or isocyanurates (trimer) or with a di- or polyol advantageously a triol or a tetraol.

It is advantageous that the Iso radical should predominantly or totally provide an aliphatic bond with the same preferences as those set out above with regard to the isocyanates.

Besides the functional group which appears in the formula, Iso advantageously carries at least one, preferably at least two isocyanate functional groups of which preferably at least one is not masked and therefore, more preferably, at least two are not masked.

Another objective of the present invention is to provide a process of the above type which makes it possible to carry out the emulsification of the abovementioned composition when it does not contain water.

This objective, and others which will appear in what follows, are attained by means of a process for emulsification which comprises at least the following step:
addition, advantageously with very moderate stirring, of the isocyanate(s) into the mixture of polyol+water.

The surface-active agent may be either in the aqueous phase or preferably in the isocyanate phase. In the former case the reactions between isocyanate and the said compound containing an anionic functional group and advantageously a polyethylene glycol chain fragment are much less considerable.

This stirring is preferably manual or mechanical.

This emulsification is advantageously conducted at a temperature that is lower than 50° C., preferably at ambient temperature.

It is desirable to carry out, if necessary, an adjustment of the pH (in order to attain a value advantageously at least equal to three, preferably to 4 and advantageously at most equal to 11 preferably to 10 and therefore advantageously between 3 and 11, preferably between 4 and 10) when emulsifying. This adjustment makes it possible to attain an advantageous range where the first (or sole) acidity of each surface-active agent according to the present invention is neutralized.

According to an advantageous alternative form of the present invention the pigments (and especially titanium dioxide) are dispersed in the polyol(s) before the addition of the isocyanate.

Another objective of the present invention is to provide a process for application of the isocyanate-based composition to form a coating.

These objectives, and others which will appear in what follows, are attained by means of a process comprising the application of a preparation layer (that is to say of composition according to the invention comprising the aqueous phase and the constituents of the layer) the thickness of which before drying is between 10 and 400 micrometres advantageously between 50 and 200 corresponding after drying to a thickness of between 5 and 150 micrometres, advantageously between 20 and 80 micrometres.

According to an advantageous application this process comprises a drying from 20° C. to 60° C. for a period that can range from ¼ to 24 hours.

This drying advantageously takes place in the presence of a solvent to assist the removal of water.

According to a particularly advantageous form of use of the present invention the application is conducted by spraying.

The preparation of the surfaces is well known to a person skilled in the art (For example phosphate treatments in the case of the steel ferrous compound or chromate treatment in the case of the alumina-based surface). (reference may be made, for example, to the following work: “organic coating technology” volume II by H. F. Payne and “Paint Handbook” Published by G. E. Weismantel) According to the present invention it is thus possible to obtain coatings (especially paints or varnishes) exhibiting the following technical characteristics (these value [sic] depend above all on the polyols employed):

application and characteristics of the coating
Iso2178 dry thickness: 45 μm
support and treatment of the latter: steel
treated by phosphating: R461 panels
from the supplier Q Pannel

| | |
|---|---|
| minimum | |
| properties | |
| obtained | usual |

| din 67530 test (these values | | | | |
|---|---|---|---|---|
| are of interest only when a | | | | |
| gloss paint is desired but | | | | |
| not when matt or satin paint | | | | |
| is wanted) | | | | |
| Gloss 20° | 0.5 | | 80 | |
| 60° | 0.5 | | 90 | |
| iso 1522 König hardness | 10 | s | 150 | s |
| din 53151 adhesiveness test | GT-1 | | GT-5 | |
| Impact strength test | | | | |
| No. iso 6272 | | | | |
| direct | 10 | cm | >100 | cm |
| reverse | 5 | cm | >100 | cm |
| Resistance to methyl ethyl | 20 | | >200 | |
| ketone (butanone) | | | | |
| (Double pass) | | | | |
| QUV outdoor behaviour | 50 | h | 800 | h |
| Din 53384 | | | | |

The following nonlimiting examples illustrate the invention.

Rhodafac® RE610 is a mixture of phosphoric mono- and diesters according to formula II, the average formula of its hydrocarbon radical is a polyethoxylated (˜ten times) nonylphenol. the molar ratio between monoester and diester is approximately 1 (mathematical rounding). Similarly Rhodafac® PA17 has as product according to the present invention a mixture of phosphoric mono- and diesters according to formula II, the average formula of its hydrocarbon radical is a polyethoxylated (^{˜}five-six times) nonylphenol.

### EXAMPLE 1

### Preparation of Mixture 1

165 g of tolonate® HDT (trimer-based isocyanurate oligomer) are mixed with 24 g of butyl acetate and 13 g of Rhodafac® RE610 (mixture of phosphoric mono- and diesters according to formula II) and 3 g of triethylamine. This mixture is stirred with the aid of a frame or deflocculating paddle for minutes at 100 revolutions/minute. This mixture has a viscosity of 0.84 Pa. At 20° C. and a colour lower than 100 APHA.

### EXAMPLE 2

### Preparation of Mixture 2

the mixture has the same composition as mixture 1 but tolonate® HDT is replaced with tolonate® HDT-LV.

The viscosity of this mixture is 0.476 Pa s. At 20° C. and a colour lower than 100 APHA.

### EXAMPLE 3

### Preparation of Mixture 3

the mixture is made with 92 g of tolonate® HDT and 10 g of Rhodafac RE610 and 2.3 g of triethylamine. The viscosity of this mixture is 5.2 Pa. At 20° C. and the colour lower than 100 APHA.

### EXAMPLE 4

30 g of mixture 1 are added to 20 g of water. The mixture is stirred with the aid of a frame paddle at 250 revolutions/min for 5 minutes. An emulsion is thus obtained the mean particle size of which is 1.2 μm. The size of the drops of emulsion remains stable for 30 hours at a pH of between 3 and 9.

### EXAMPLE 5

30 g of mixture 3 are added to 20 g of water. The emulsion is prepared in the same conditions as in Example 4. The mean size of the drops is 1.1 μm.

### EXAMPLE 6

### Comparative

30 g of an HDT-LV/butyl acetate mixture (same weight ratio as in Example 2) are added to 20 g of water. The emulsion is prepared in the same conditions as in Example 4. A coarse emulsion is thus obtained, the mean size of which is larger than 5 μm and therefore difficult to characterize.

### EXAMPLE 7

### Comparative

165 g of tolonate® HDT are mixed with 13 g of Rhodocal® AT60 (triethylamine dodecylbenzenesulphonate). This mixture is stirred with the aid of a frame paddle at 100 revolutions/min. For 5 minutes. 10 g of this mixture are added to 90 g of water with stirring with the aid of a frame paddle at 400 revolutions/min. For 10 minutes. The product is then analysed, it consists of two phases, one rich in oil and the other rich in water but there is no formation of a homogeneous emulsion.

### EXAMPLE 8

83 g of tolonate® HDB (biuret) are mixed with 6 g of Rhodafac® PA17 and 1.2 g of triethylamine and 10 g of butyl acetate. This mixture is homogenized with the aid of a frame paddle at 100 revolutions/min. For 5 minutes.

10 g of this mixture are added to 90 g of water with stirring with the aid of a frame paddle at 200 revolutions/min. For 5 minutes. The emulsion obtained has a particle size centred around 3.5 μm.

### EXAMPLE 9

83 g of tolonates® HDT are mixed with 6 g of Rhodafac® PA17 and 1.2 g of triethylamine and 10 g of butyl acetate. This mixture is homogenized with the aid of a frame paddle at 100 revolutions/min. For 5 minutes.

10 g of this mixture are added to 90 g of water with stirring with the aid of a frame paddle at 200 revolutions/min. For 5 minutes. The emulsion obtained has a particle size centred around 0.98 μm.

### EXAMPLE 10

Preparation of a varnish from mixture 1 and from a polyol marketed by the Company SC Johnson Polymer under the name of Joncryl®540.

This polyol is an emulsion of acrylic copolymers of solids content 42% and hydroxyl value 42 (on dry material).

A varnish is prepared by incorporating 7.3 g of mixture 1 into 92.7 g of Joncryl® 540. The incorporation is done with manual stirring with a spatula for 10 minutes. The proportions of the mixture 1 and the polyol are such that the NCO/OH molar ratio is equal to 1/1.

Films of varnish were applied with a threaded rod (so as to have a dry thickness of 42 μm) ½ hour and 4 hours after the incorporation of the isocyanate into the polyol.

The performances obtained at ½ hour and 4 hours′ aging of the mixture, after 48 hours′ drying at 23° C. and 55% relative humidity, are equivalent and of a good level: gloss of 89 at an angle of 20°, resistance to Methyl Ethyl Ketone greater than 100 to-and-fros with a soaked cotton rag, Persoz pendulum hardness equal to 140 s.

### EXAMPLE 11

Preparation of a gloss white paint from mixture 2 and from a polyol

A paint will consist of 2 components: a component A containing in particular and in most cases pre-dominantly the pigment and the polyol, and a component B consisting solely of the mixture 2.

The polyol employed in the present example is that marketed by the Jager company under the name of Jagotex® F 313.

This polyol is an aqueous solution of a resin of acrylic copolymers containing acidic and hydroxyl groups. It is neutralized with Di Methyl Ethyl Amine at a pH of 8.5, it has a solids content of 45%, an acid value of 60 and a hydroxyl value of 132.

100 g of component A are obtained by mixing with vigorous stirring (20 minutes at 1000 revolutions/min with a deflocculating paddle) 49.7 g of Jagotex® F 313, 0.8 g of Disperbyk® 181 (wetting agent marketed by the company Byk), 0.3 g of Byk® 022 (antifoam agent marketed by the company Byk), 23.7 g of Titafrance® RL 60 (titanium dioxide pigment marketed by the company Rhone-Poulenc) and 25.5 g of demineralized water.

A paint is prepared by incorporating, with reduced stirring (approximately 300 revolutions/min with deflocculating paddle) 3.9 g of component B (mixture 2) into component A. These proportions are such that the Pigment/Binder ratio of the paint is equal to 0.75/1 and that the NCO/OH ratio in the paint is equal to 1/1.

Films of paint were applied onto steel panels with a threaded rod (so as to have a dry thickness of 30 μm) ½ hour after the incorporation of the isocyanate into the polyol. The duration of use of the paint (mixture A+B) is 3 hours.

The performances of the films after 48 hours′ drying at 23° C. and 55% relative humidity are of a good level: gloss of 71 at an angle of 20° and 84 at an angle of 60°, resistance to Methyl Ethyl Ketone greater than 100 to-and-fros with a soaked cotton rag, Persoz pendulum hardness equal to 100 s, “tack-free” drying time equal to approximately 3 hours at 23° C. and 55% relative humidity.

### EXAMPLE 12

Preparation of a white paint from the mixture of Example 6 and from the polyol Jagotex® F 313 marketed by the Jager company (cf. Characteristics given in Example 12).

The paint will be obtained by mixing a component A containing the pigment and the polyol and a component B consisting solely of the mixture of Example 6.

Component A is prepared according to the process and the formula of Example 11.

The paint is prepared by incorporation, with reduced stirring (approximately 300 revolutions/min with deflocculating paddle), of 3.6 g of component B (mixture from example 6) into component A. These proportions are such that the Pigment/Binder ratio of the paint is equal to 0.75/1 and that the NCO/OH ratio in the paint is equal to 1/1 (conditions identical with those of Example 11).

Films of paint were applied in the same conditions as those of Example 11.

The performances of the films after 48 hours′ drying at 23° C. and 55% relative humidity are mediocre: gloss of 8 at an angle of 20° and 27 at an angle of 60° and resistance to Methyl Ethyl Ketone lower than 10 to-and-fros with a soaked cotton rag.

Comparison of this example and of example 11 shows the potentialization brought about by the combination with Rhodafac RE 610 surfactant, in particular neutralized with triethylamine.

### EXAMPLE 13

### Use of Nanolatex

Preparation of a varnish from mixture 1 and from a nanolatex (that is to say latex whose particle size is Nanometric [more precisely whose d₅₀ is at most equal to approximately 100 nanometresl] of acrylic monomers.

The nanolatex employed is an experimental product produced according to the process described in the French Patent Application filed on 28 Apr. 1995 No. 95/05123 and in the European Patent Reflex Application No. EP 0,739,961, with following characteristics:
d₅₀: approximately 35 nm
carboxylate function: 2.6% by weight on the dry polymer
ol functional group: 2.6% by weight on the dry polymer
Molecular mass greater than 100 000
Solids content by weight: 30%
pH approximately 8
Minimum Film Forming Temperature approximately 20° C.
Glass transition temperature approximately 40° C.

The varnish is prepared by incorporating, with manual mixing, 4.6 g of mixture 1 into 45.6 g of nanolatex. This ratio corresponds to a ratio of the functional groups NCO/OH of 1.2.

The mixture thus prepared has a lifetime of 4 hours, this means that for 4 hours the viscosity and the appearance of the mixture is unchanged but also that the films formed from this mixture during these 4 hours have unchanged properties like solvent resistance, hardness and gloss.

The drying time of the film is remarkably short: 20 minutes for the “dust-free” time and 30 minutes for the “tack-free” time according to NF standard T30037. These measurements were.made on glass plates for a film dry thickness of 40 μm and drying at 23° C. with 55% relative humidity.

The fact of obtaining a short drying time and a relatively long lifetime of the mixture constitutes an advantage which is greatly sought after by paint experts.

The wear values of the coating are also of a very good level overall, it is possible to mention:
the Persoz hardness of the dry 50 μm film, measured on a steel panel after drying for 24 hours at 23° C. and 55% relative humidity is equal to 275 seconds.
the gloss at an angle of 20° of the film applied onto a steel panel is equal to 90
the resistance to Methyl Ethyl Ketone of the film dried for 7 days at 23° C. and 55% relative humidity is greater than 200 to-and-fros with a soaked cotton rag.

These excellent performances of this Nanolatex-polyisocyanate combination according to the invention are certainly attributable to the very special physico-chemistry of these products, especially to the very large specific surface of the nanolatex, which promotes a great homogeneity of crosslinking in the final polymer.

### EXAMPLE 14

The mixture prepared in example 13 is applied using the brush with a deposit of 200 g/m² onto a concrete-type substrate.

After drying for 1 h at ambient temperature the coating offers a water repellency of the substrate which is reflected in a pearl-like effect and a lower water-absorption. In addition the coating exhibits good resistance to abrasion.

### EXAMPLE 15

Preparation of a coating from mixture 1 and from a nanolatex of acrylic monomers.

The nanolatex is an experimental product according to invention application No. [lacuna] of following characteristic:
d₅₀: approximately 35 nm
carboxylate function: 1% by weight on the dry polymer
ol functional group: 2.6% by weight on the dry polymer
Molecular mass greater than 100 000
Solids content by weight: 30%
pH approximately 8
Glass transition temperature approximately −30° C.

The varnish is prepared by incorporation, with manual mixing, of 4.6 g of mixture 1 into 45.6 g of nanolatex. This ratio corresponds to a ratio of the functional groups NCO/OH of 1.2.

The coating is applied to concrete with the brush at a rate of 2 coats of 300 g/m2. Its great flexibility, due chiefly to the low Tg of the nanolatex, gives it a capacity for masking the crack which can appear as the substrate ages (especially because of the expansion of the concrete because of the large temperature variation).

In addition the crosslinking with the polyisocyanate according to the invention gives the coating an excellent resistance to chemical agents and to water.

1-27. (canceled)

28. A coating composition, consisting essentially of, in emulsion in water, a composition autodispersible in aqueous phase which is a mixture of an aliphatic isocyanate composition, with at least one surfactant containing an anionic functional group, a countercation and, a polyethylene glycol chain fragment having one or more ethyleneoxy units, wherein the anionic functional group of said surfactant corresponds to the following formula: 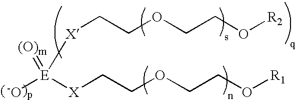
wherein:
q is zero or 1;
pis 1 or 2;
m is 0 or 1;
the sum: 1+p+2m+q is equal to three or to five;
X and X′ are a divalent group;
s is an integer chosen between 1 and 30;
n is an integer chosen between 1 and 30;
E is a phosphorus atom; and
R₁ and R₂ are a hydrocarbon radical.

29. A coating composition according to claim 28, wherein the mass ratio between the surfactant and the isocyanate is between 4 and 10%.

30. A coating composition according to claim 29, for coating a ferrous compound or alumina support.

33. A coating composition according to claim 28, wherein the aliphatic isocyanate is not completely masked.

34. A coating composition according to claim 28, whose pH is at least equal to 3 and at most equal to 11.

35. A coating composition according to claim 28, wherein the anionic functional group is phosphonium, tertiary ammonium, quaternary ammonium, or sulphonium.
